(19) United States
(12) Patent Application Publication
(10) Pub. No.: US 2007/0280981 A1
(43) Pub. Date: Dec. 6, 2007

(54) ADHERENT BIOLOGICALLY ACTIVE INGREDIENT CARRIER GRANULE

(75) Inventor: Timothy D. Birthisel, Perrysburg, OH (US)

Correspondence Address: GIFFORD, KRASS, SPRINKLE,ANDERSON & CITKOWSKI, P.C, PO BOX 7021, TROY, MI, 48007-7021, US

(73) Assignee: The Andersons, Inc.

(21) Appl. No.: 11/757,646

(22) Filed: Jun. 4, 2007

Related U.S. Application Data
(60) Provisional application No. 60/810,763, filed on Jun. 2, 2006.

(51) Int. Cl. A01N 25/00

(52) U.S. Cl. 424/405

(57) ABSTRACT

A composition is provided that includes an inventive biologically active ingredient carrier granule that adheres to the surface of plants, grasses, and weeds using a moisture-active coating, illustratively including gum Arabic, guar gum, gum karaya, gum tragacanth and locust bean gum. Upon application of the inventive granule onto a plant surface, water from precipitation, irrigation, dew, co-application with the granules from special application equipment, or guttation water from the plant itself, provides sufficient moisture for adherence of the granule to the plant surface.

### RELATED APPLICATIONS

This application claims priority benefit of U.S. Provisional Application Ser. No. 60/810,763, entitled Adherent Biologically Active Ingredient Carrier Granule, filed Jun. 2, 2006, which is incorporated herein in its entirety.

### FIELD OF THE INVENTION

The present invention in general relates to a biologically active ingredient granule and in particular to a biologically active ingredient granule that is adherent to desired plant species.

### BACKGROUND OF THE INVENTION

Biologically active ingredients are widely used in agriculture, landscape and turf management to kill or regulate the growth of desired or unwanted plants, diseases, insects or other pests and/or to nourish, protect, regulate the growth, or enhance the appearance of desired plants, and/or to modify the behavior of animals interacting with plants. In the course of a growing season, modern plant culture may dictate multiple treatments with biologically active ingredients. A practitioner of plant culture must decide whether a particular treatment is best performed with a granular product or a liquid spray application. Crops as diverse as turf, grain crops, tubers, ground fruits and vegetables, and horticultural plantings are routinely treated with either granular or sprayed substances. Each application method has limitations. Specifically, while granule herbicide broadcast tends to provide a simple broadcast, generally long-term release, accurate placement of product in the treated area, relative freedom from spills and other environmental releases, and safer handling, granules are difficult to adhere to plant surfaces.

In contrast, spray treatment generally requires considerable skill for application, may contact only exposed foliage and may tend to dissipate, or “run off,” quickly. Based on these treatment characteristics, biologically active materials targeting weed leaves or foliage tend to be applied as a liquid spray, despite the associated problems.

Regardless of whether spray or granule broadcast is used, the application method is not completely satisfactory. For instance, spray application is quickly dissipated and leached into soil by rain. Granular formulations often require the use of additional herbicide due to inefficiencies in the timely release, or efficient environmental extraction, of the herbicide from the associated granular substrate materials.

The present invention addresses these limitations of the prior art through inclusion of an inventive biologically active ingredient carrier granule that adheres to the surface of plants, grasses and weeds using a moisture-active coating, illustratively including gum arabic, guar gum, gum karaya, gum tragacanth and locust bean gum. Upon application of the inventive granule onto a plant surface, water from precipitation, irrigation, dew, coapplication with the granules from special application equipment, or guttation water from the plant itself provides sufficient moisture for adherence of the granule to the plant surface.

### SUMMARY OF THE INVENTION

A composition is provided that includes an inventive biologically active ingredient carrier granule that adheres to the surfaces of plants using a moisture-activated tacky coating. Preceding or after application of the inventive granule onto a plant surface, water from precipitation, irrigation, dew, co-application with the granules from special application equipment, or guttation water from the plant itself, provides sufficient moisture for adherence of the granule to the plant surface. The granule includes a carrier particle having a surface with a lipophilic tackifier coated on the surface. A moisture-activated coating is adhered to the carrier particle by contact with the tackifie. A biological active ingredient is provided within carrier particle, within a coating on the particle, or a combination thereof. As the granules adhere to the plant surface active ingredient is used more efficiently allowing for less usage to obtain a desired effect relative to conventional granules that settle to the soil surface.

### BRIEF DESCRIPTION OF THE FIGURES

FIGS. 1A-D depict a progressive sequence of an inventive granule change when contacted with water.

### DETAILED DESCRIPTION OF THE PREFERRED EMBODIMENTS

The present invention has utility as a granule to deliver a biologically active ingredient to plant culture. An inventive granule, upon contact with a plant surface, adheres to the plant surface to facilitate the distribution and retention of the biologically active ingredient to the plant leaf and stalk surfaces.

The inventive granule retains its size and shape during handling and application to a desired area and adheres to plant surfaces when the granule comes into contact. Thus the durability of the particle affords both ease of application and adherence of the granule on a desired site of action when sufficient moisture is present to wet the granule surface, facilitating distribution and retention of biologically active ingredients to a target. As stated above, even without the presence of added water from rain or irrigation, the moisture present on a plant surface is often sufficient to activate the adherent coating of the inventive granule.

A base carrier particle operative in the present invention need only be well sized for broadcast distribution and be inert towards an overlying coating of liquid pesticide and as such is not critical to the practice of the present invention. Typically, a base carrier particle has a size from 500 to 3000 microns. Suitable carrier particles include fragmented materials such as rock dust, clay, corncob, cereal or grain hulls, peanut hulls, plant pulp, other plant-based cellulosic materials, stones, clays, and bait particulate, specific examples of which include limestone particulate having a mean particle size of 1000 microns, blended fertilizer comprised of urea, diammonium phosphate, and potassium chloride having a mean particle size of 2150 microns, and processed snack food or defatted, extruded corn granules having a mean particle size of 1500 microns, Alternatively, a carrier particle is formed through the combination of a binder component with fine grain particle as detailed above has 90% of the particles having a diameter less than 150 microns, Particulate is typically present from 0.1 to 99.9 total weight percent and preferably from 5 to 98 total weight percent.

A plasticizer is optionally added during or after the formation of a granule. By virtue of the inclusion of impregnated plasticizer according to the invention, the resulting granules are well suited to readily absorb substantial and repeated impacts, shears, or compressions. The plasticizer-containing granule tends to deform while maintaining its integrity, increasing the attritional forces the inventive granule can absorb before reaching a point of catastrophic failure. The amount of fragments or dust formed as a result of such mechanical attrition is also reduced. A plasticizer, such as glycerol, when introduced, results in the plasticizer being absorbed into the interior of the granule and incorporated into the granule without resulting in agglomeration.

When the plasticizer is introduced as a post-formation granule coating, the plasticizer provides to reformulate a granule to increase mechanical robustness. It is noted that the process of converting mechanically sensitive granules to mechanically robust granules does not diminish desirable properties such as ease of production, handling, solubility, enzymatic stability, thermal stability, and resistance to water pickup during storage in humid conditions.

Suitable plasticizers which are incorporated into the granule are nonvolatile solvents which reduce the brittleness and enhance deformability of the granule. Typically plasticizers are low molecular weight organic compounds generally with molecular weights between 50 and 1000. Examples include, but are not limited to, polyols (polyhydric alcohols), for example alcohols with many hydroxyl groups such as glycerol, glycerin, ethylene glycol, diethylene glycol, triethylene glycol, propylene glycol, dipropylene glycol, polyethylene glycol; polar low molecular weight organic compounds, such as urea, sugars, sugar alcohols, oxa diacids, diglycolic acids; and other linear carboxylic acids with at least one ether group, C₁-C₁₂ dialkyl phthalates. Other plasticizers operative herein illustratively include ethanolacetamide; ethanolformamide; triethanolamines such as triethanolamine acetate; thiocyanates, such as sodium and ammonium thiocyanates. Most preferred as plasticizers are glycerol, triethylene glycol, propylene glycol, sorbitol, and polyethylene glycol having an average molecular weight below about 600. Generally, the ratio of plasticizer to polymer ranges from about 0.05 to about 5.0. The plasticizer is preferably present at a level of about 0.05 to about 25% by weight of total dry weight of the granule, preferably about 1 to 10% by weight of total dry weight of the granule; and more preferably about 1.5 to about 5.0% by weight of total dry weight of the granule. The exact level depends on factors such as plasticizer identity, granule size, and plasticizer tack.

A binder component is present in a carrier particle in an amount ranging from 0.1% to 75% by weight of the total dry weight of the carrier particle. In a further embodiment, the tackifier is present in an amount ranging from 1% to 25% by weight of the total dry weight of the particle. A binder component is included in a particle as necessary to produce or promote cohesion in forming a particle capable of retaining a specified form during transport and/or distribution. A binder component illustratively includes bentonite clay, carbohydrate, protein, lipid, synthetic polymer, glycolipid, glycoprotein, lipoprotein, lignin, a lignin derivative, a carbohydrate-based composition, and a combination thereof. In a preferred embodiment the binder component is a lignin derivative and is optionally calcium lignosulfonate. Alternatively, the binder component is selected from the group consisting of: a monosaccharide, a disaccharide, an oligosaccharide, a polysaccharide and combinations thereof. Specific carbohydrate binders illustratively include glucose, mannose, fructose, galactose, sucrose, lactose, maltose, xylose, arabinose, trehalose and mixtures thereof such as corn syrup; celluloses such as carboxymethylcellulose, ethylcellulose, hydroxyethylcellulose, hydroxy-methylethylcellulose, hydroxymethylpropylcellulose, methylhydroxyethyl-cellulose, methylcellulose; starches such as amylose, seagel, starch acetates, starch hydroxyethyl ethers, ionic starches, long-chain allyl starches, dextrins, amine starches, phosphates starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth and locust bean gum; vegetable oils such as corn, soybean, peanut, canola, olive and cotton seed; complex organic substances such as lignin and nitrolignin; derivatives of lignin such as lignosulfonate salts illustratively including calcium lignosulfonate and sodium lignosulfonate and complex carbohydrate-based compositions containing organic and inorganic ingredients such as molasses. Suitable protein binders illustratively include soy extract, zein, protamine, collagen, and casein. Binders operative herein also include synthetic organic polymers capable of promoting or producing cohesion of particle components and such binders illustratively include ethylene oxide polymers, polyacrylamides, polyacrylates, polyvinyl pyrrolidone, polyethylene glycol, polyvinyl alcohol, polyvinylmethyl ether, polyvinyl acrylates, polylactic acid, and latex. In a preferred embodiment, the binder is calcium lignosulfonate, molasses, a liquid corn starch, a liquid corn syrup or a combination thereof.

Water dispersible polymers are optionally coated onto inventive granules. Water dispersible polymers function to break up an inventive granule into fine particles of no greater than about 50 microns at room temperature within about 10 minutes of moderate agitation in deionized water or a solution of less than about 5% of a detergent or nonionic surfactant. Moderate agitation is applied through the use of a stir bar at a speed in the range of 100 to 300 rpm. The water dispersible polymer is at least suspendable in water and preferably has a solubility of at least 1% by total solution weight, more preferably at least 5% in deionized water at room temperature.

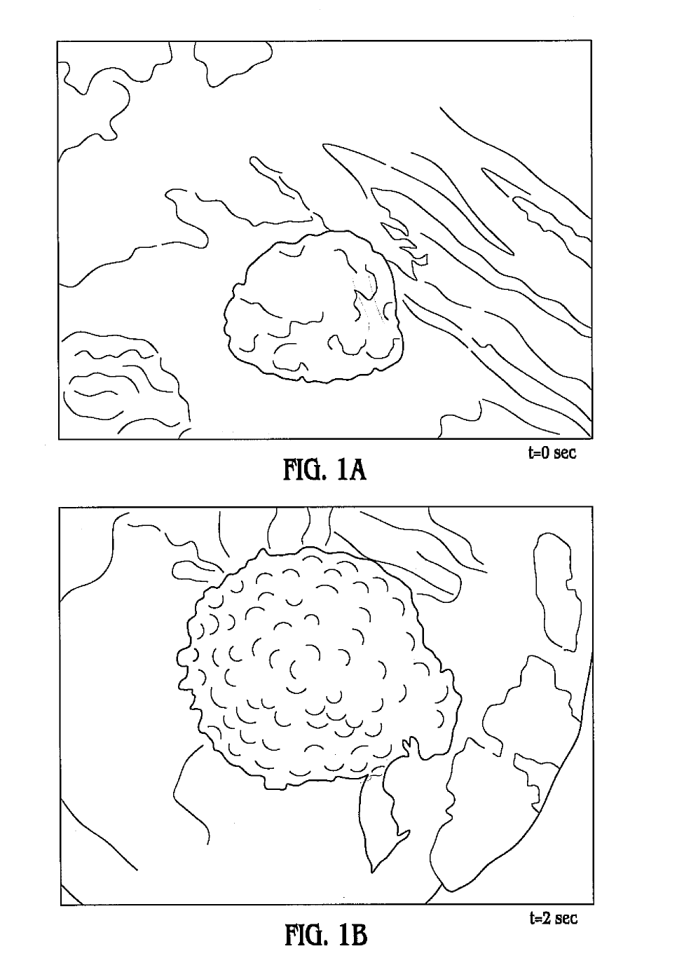

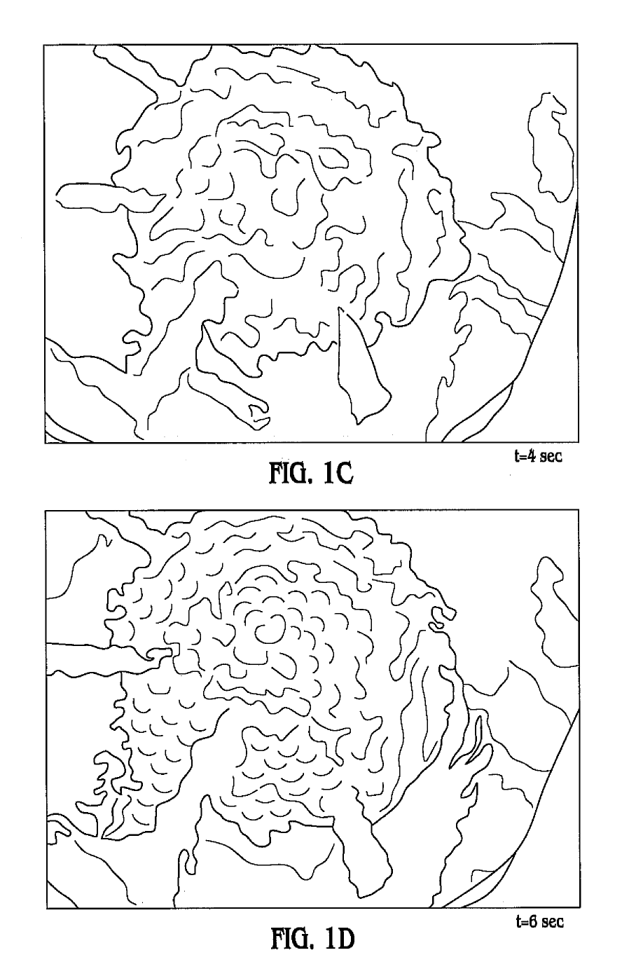

An inventive granule disperses by breaking up into greater than 100 smaller pieces upon contact with water over a period of time ranging from 1 second to 24 hours. Preferably, an inventive granule disperses into 1,000 to 10,000 smaller pieces over a period of time ranging from 1 second to 12 hours. Even more preferably, a granule disperses into 100 to 10,000 smaller pieces over a period of 30 seconds to 6 hours. Most preferably, an inventive granule disperses as described over a period of 5 seconds to 5 minutes. The swelling and dispersion of an inventive granule is depicted graphically in FIGS. 1A-1D as renderings derived from video imagery. FIG. 1A depicts a dry granule (t=0 sec), while FIGS. 1B-1D depict swelling and dispersion at times of 2, 4, and 6 seconds, respectively.

The ability of the inventive material to degrade with water is generally measured in a water dispersibility test. The test involves placing about 10 grams of the inventive granules into 100 ml of water at room temperature in a closed glass container. The container is then inverted and the time is observed until the material disperses. After every minute, the container is inverted. The inventive granules have a dispersibility time of generally less than 15 minutes with a period of less than 5 minutes being preferred and a period of less than 2 minutes being most preferred. The inventive particle provides a delivery system for controlled release nitrogen, and optional additional agents such as plant nutrients, pesticides, hormones, herbicides, micronutrients and other active ingredients.

The water dispersible polymers have a molecular weight of more than 1,500 and are water-soluble or at least water suspend-able. The water dispersible polymers illustratively include polyvinyl alcohols (PVA), polyethylene glycols (PEG), polyethylene oxides (PEO), polyvinyl pyrrolidones (PVP), cellulose ethers, alginates, gelatin, modified starches and substituted derivatives, hydrolysates and copolymers thereof. Most preferred polymers are PVA, cellulose ethers, such as methyl cellulose and hydroxylpropyl cellulose, gelatin and modified starches, such as hydroxypropyl starch produced from cornstarch. Mostly preferred is PVA. The polymers may be utilized in a foamed morphology. If PVA is used, in a preferred embodiment the polymer has a level of hydrolysis in the range of about 50 to 99%, at least about 80%, at least about 85%, at least about 90%, and at least about 95%. The polymer may have an average molecular weight of about 4,000 to 250,000, preferably from 5,000 to 200,000; also from 10,000 to 100,000. The polymer generally constitutes about 0.05% to about 10% total weight of the granule.

The carrier particle incorporates a biologically active ingredient (BAI) therein or coated on the carrier particle surface. The biologically active ingredient (BAI) is present in an amount ranging from 0.05% to 50% by weight of the total dry weight of the carrier particle. The biologically active ingredients (BAI) incorporated with the carrier particle illustratively include herbicides, insecticides, fungicides, plant growth regulators, pest reproductive control agent, other pesticides, macro (or primary) plant nutrients, secondary plant nutrients, micronutrients, biostimulants, or protective/coloring agents used to coat or alter the appearance of plant surfaces for agronomic or aesthetic purposes, as well as other protectant and enhancing materials.

Herbicides, for purposes of this invention, include a wide array of chemical and biological compositions which include materials in the functional, or mode of action categories of desiccants, defoliants, abscission agents, algaecides, moss control agents (silicides), acetyl coenzyme A carboxylase inhibitors, acetolactate synthase enzyme inhibitors, synthetic auxins (action like indoleacetic acid), inhibition of auxin transport, inhibitors of photosynthesis at photosystem II Site A and others with different binding behavior, inhibition of DHP (dihydropteroate) synthase, inhibition of acetyl CoAcarboxylase (ACCase), inhibition of lipid synthesis (not ACCase inhibition), inhibitors of 5-enolpyruvylshikimate-3-phosphate (EPSP) synthase or EPSPS inhibitor, inhibition of 4-hydroxyphenyl-pyruvate-dioxygenase (4-HPPD) (bleaching), inhibitors of glutamine synthetase, inhibitors of carotenoid biosynthesis, inhibition of carotenoid biosynthesis at the phytoene desaturase step (PDS) (bleaching), inhibition of all diterpenes, inhibitors of protoporphyrinogen oxidase (PPO), inhibitors of dihydropteroate (DHP) synthase step, inhibitors of indoleacetic acid action, inhibitors of cell wall (cellulose) synthesis, Site A inhibitors of cell wall synthesis, Site B photo system I-electron diverters, inhibition of photosynthesis at photosystem II, inhibitors of mitosis, uncoupling membrane disruptors, inhibition of 4-hydroxyphenyl-pyruvatedioxygenase (4-HPPD), enolpyruvylshikimate 3-phosphate synthase enzyme inhibitors, synthetic auxins, uncoupling (membrane disruption), inhibition of VLCFAs (inhibition of cell division), inhibition of mitosis/microtubule organization, microtubule assembly inhibition, and other, unknown mechanisms. Biological, or biorational, herbicides with application to this invention fall generally into the categories of bacteria, fungi, viruses, and plants, including the spore and other reproductive forms thereof extracts derived therefrom, and including naturally occurring and genetically engineered forms.

More particularly, herbicides commonly fall into one (or more, in the case of mixtures) of the following chemical families: aryloxyphenoxy propionates, arylaminopropionic acid, arsenicals, cineole (such as cinmethylin), cyclohexanediones, sulfonylureas, imidazolinones, pyrimidinylthio-benzoate, triazolopyrimidine, dinitroanilines, pyridazine, phenoxys (or phenoxies), benzoic acids, carboxylic acids (such as DCPA, clopyralid, trichloroacetic acid, and fluoroxypyr), quinoline carboxylic acid, semicarbazone, triazines, triazinones, uracils, pyridazinone, phenyl-carbamates, nitriles, benzothiadiazoles, organoarsenicals, phenyl-pyridazine, ureas and substituted ureas (such as diuron, linuron, siduron, tebuthiuron, dymron etc.), amide (such as propanil and bromobutide), thiocarbamates, organophosphates (such as bensulide), pyrazolium (such as difenzoquat), phosphoric acid compounds (such as glufosinate-ammonium and glyphosate), triazole, pyridazinone, nicotinanilide, pyridinone (such as fluridone), isoxazolidinone, diphenylethers, N-phenylphthalimides, oxadiazole, triazolinone, chloroacetamides, oxyacetamides, carbamate (such as asulam), phthalamate, phthalamate semicarbazone, nitrile, N-phenylphthalimides, oxadiazole, triazolinone, acetamides, benzoylisoxazole, isoxazole, pyrazole, pyrazolium, triketone, and benzofuran, biological herbicides including Puccinia canaliculata Puccinai jacea, Xanthomonas campestris, Alternaria destruens, Colletotrichum gloeosporioides, Dendryphion papaveraceae, Pseudomonas syringae, including any varieties or subspecies thereof. Examples of plant extract herbicides are corn gluten meal and the allelopathic exudates of various plants.

For purpose of this invention, a pest reproductive control agent operative herein includes a pheromone, molting signaling compound or steroid that upon contact with the target pest decreases the reproductive capacity of the pest. A pest reproductive control agent is preferred over a pesticide since a reproductive control agent is specific to a species or narrower group of organisms, does not bioaccumulate, and is less detrimental to predatory or bystander organisms in the pest habitat. Additionally, a reproductive control agent is unlikely to avoid the bait due to ill health effects associated with sampling, as is often the case with a lethal pesticide.

The pest reproductive control agent includes agents such as an acaracide, an antimicrobial, a bactericide, an entomopathogen, a fungicide, a synthetic plant growth regulator such as a gibberlic acid synthesis inhibitor or promoter, an herbicide, an insecticide, a molluskicide, a nemacide, a rodenticide, a pheromone, a chemosterilant, a viricide, an imagocide, a larvicide, an ovicide, a formicide, an aphidicide, a muscacide, a culicicide, an anophelicide, an arachnidcide, and a vespacide. Preferably, an inventive bait particle containing a toxic invertebrate pesticide also contains a mammalian and/or avian ingestion repellant. More preferably, it also contains both mammalian and avian ingestion repellents to lessen the likelihood of incidental ingestion by stander higher species. Mammalian ingestion repellants illustratively include cadaverine, butyric acid, and capsaicin. Avian repellants include artificial grape flavorant.

For purposes of this invention, plant and general disease control agents include fungicides, fungistats, antibiotics and bactericides of the following chemical families and functional groupings; various acetamides, sterol inhibitors or demethylase inhibitors, dicarboximides (such as iprodione), phthalides, phthalmic acids, triadiazoles, isophthalates, triazines, triconazoles, strobilurins, benzimidazoles, benzothiazoles, dithiocarbamates, carboxamides, carboxides or anilides, chlorphenyls, indolecarboxylic acids, isoxazoles, imidazoles, oxazolinediones, guanidines, diguanidines, piperidines, pyridines, sulfenamides, sulfonamides, quinolines, cyanoimidazoles, pyrazoles, pyrrolecarbonitriles, spiroketalamines, thiazoles, various chemical families of oomycete (pythium) fungicides, nitriles, chlorinated hydrocarbons, phenylpyrroles, polyoxins, pyridazinones, mycotoxins (e.g. penicillin) or other antibiotics (e.g. streptomycin, kasugamycin, blasticidin, polyoxins, validamycin, mildiomycin, and oxytetracycline), morpholines, other organic compounds such as piperalin, piperazine derivatives and tolylfluanid, bronopol, organic compound mixtures (e.g. Bacticin and harpin protein), organic acids such as cinnamic acid and its derivatives, bacteria such as Agrobacterium radiobacter, Bacillus subtilus, Erwinia carotovoa, Pseudomonas flourescens and P. chlorophis, and any varieties or strains thereof, fungi such as Candida oleophila, Fusarium, Tricoderma, Gliocladium, Streptomyces and Ampelomyces and any species, varieties or strains thereof, and viruses such as Tomovax.

For purposes of this invention, insecticides and acaricides include fast- and slow-acting neurotoxins, insect growth regulators, crop oil, feeding suppressants and repellants, acetylcholinesterase inhibitors, gamma-aminobutyric acid (GABA)-gated chloride channel antagonists, GABA-gated chloride channel antagonists, sodium channel modulators, acetylcholine receptor agonists/antagonists, acetylcholine receptor modulators, chloride channel activators, juvenile hormone mimics, feeding disruptors, mite growth inhibitors, ovicides, reproductive inhibitors, reproductive sterilants, microbial disruptors of insect mid-gut membranes, inhibitors of oxidative phosphorylation at the site of dinitrophenol uncoupling [disrupt adenosine triphosphate (ATP) formation], uncouplers of oxidative phosphorylation (disrupt H proton gradient formation), inhibitors of magnesium-stimulated ATPase, Ecdysone agonist/disruptors (disrupts insect molting by antagonizing the insect hormone ecdysone), octopaminergic agonists, Site I and Site II electron transport inhibitors, inhibitors of chitin biosynthesis type 1-Homopteran, inhibitors of chitin biosynthesis type 2-Dipteran, desiccants, fumigants, carbamates, organophosphates, chlorinated cyclodienes, polychlorocycloalkanes, phenylpyrazoles, diphenylethanes, synthetic pyrethroids, pyrethrins, chloronicotines, (nitroguanidines), nicotine, Cartap, Bensultap, Spinosyns, Avermectin, Milbemycin, juvenile hormone analogues, Bt microbials (biological insecticide/larvicide), organotin matricides, pyrrole compound, sulfite ester matricides, substituted benzoylurea, thiadiazine, triazine, benzoic acid hydrazide, botanicals (neem oil or azadirachtin, rotenone), triazapentadiene, pyridazinone, and fatty acid soaps.

For purposes of this invention, plant growth regulators are ingredients such as trinexepac-ethyl, gibberellic acid, gibberellins, cytokinins, benzyladenine, glycines, quinolines, phosphoric acid compounds, organic carbamates, quaternary ammonium compounds, acetamides, ethychlozate, azoles, paclobutrazol, anilides, pyradazidine, pyrimidines, napthaleneacetamide, phthalimides, phenoxies, pyrimidines, hybridizing agent, biostimulants, seaweed extracts and herbicides (typically at low use rates), phthalimides, phenoxies, organic or carboxylic acids (e.g. gamma amino butyric acid and L-glutamic acid, napthalene acetic acid, clofencoet, sintofen, nicotinic acids), and herbicides (typically at low use rates).

For purposes of this invention, other pesticides include animal and bird repellants, bitter flavors, irritants, and malodorous ingredients, molluscicides (e.g., slugs and snails), nematicides, rodenticides, defoliants, chemosterilants, plant defense boosters (harpin protein and chitosan) desiccants (may also be used as a harvest aid), and other beneficial or detrimental agents applied to plant or other surfaces.

For purposes of this invention, other protectants and beneficial ingredients include attractants, baits, herbicide safeners, antidessicants, antitranspirants, frost prevention aids, inoculants, dyes, brighteners, markers, synergists, pigments, UV protectants, antioxidants, leaf polish, pigmentation stimulants and inhibitors, surfactants, moisture retention aids, humic acids and humates, lignins and lignates, molluscicides (e.g., slugs and snails), nematicides, rodenticides, defoliants, desiccants, sticky traps, and IPM lures.

Optionally, the carrier particle incorporates a fertilizer, soil nutrient, amendment material, or other active agent such as a biologically active ingredient (BAI), fungicide, pesticide or the like. In a carrier particle incorporating a fertilizer, soil nutrient or amendment material, the fertilizer, soil nutrient or amendment material is present in an amount ranging from 0.05% to 50% by weight of the total dry weight of the carrier particle. In a more preferred embodiment, the fertilizer, soil nutrient or amendment material active ingredient is present in an amount ranging from 0.1% to 30% by weight of the total dry weight of the particle. In a still more preferred embodiment, the fertilizer, soil nutrient or amendment material active ingredient is present in an amount ranging from 0.5% to 10% by weight of the total dry weight of the particle.

Fertilizers are substances containing one of the plant nutrients nitrogen, phosphate or potassium and illustratively include urea, sulfur-coated urea, isobutylidene diurea, ammonium nitrate, ammonium sulfate, ammonium phosphate, triple super phosphate, phosphoric acid, potassium sulphate, potassium nitrate, potassium metaphosphate, potassium chloride, dipotassium carbonate, potassium oxide and a combination of these. Soil nutrients illustratively include calcium, magnesium, sulfur, iron, manganese, copper, zinc; oxides thereof, salts thereof and combinations thereof. Amendment materials are natural organic products such as humic acid, blood meal, bone meal, seed meal, feather meal and soy meal; meat meal; animal waste from various animal sources; activated sludge, hydrolyzed animal hair; fish byproducts; chitin; composts; and a combination thereof.

An inventive granule is produced by a number of processes. In one particular instance of the present invention, granule components including carrier particles, tackifiers, biologically active ingredients, and optionally plasticizers, are wet granulated through a process of steps, including mixing of various dry components, wet massing the dry powder mixture with liquid surfactants, binders or the like, alone or with the addition of a solvent to arrive at a suitable consistency for granulating. Resulting powder mixture is compressed into a large form that is subsequently ground to a desired size. It is appreciated that dry granulation is facilitated by the addition of a pressing agent, such as a stearate salt. Upon forming a granule, a granule is optionally coated with water dispersible polymers.

Alternatively, an inventive granule is made through a layering coating process on carrier particles. Upon forming a carrier particle, a liquefied formulation of a biologically active ingredient (BAI) is applied to a carrier particle surface. Preferably, the biologically active ingredient (BAI) is dissolved in a solvent. Alternatively, it is appreciated that the liquid biological guttationly active ingredient (BAI) formulation is incorporated into a binder solution that promotes cohesion in the forming of the carrier particle with the proviso that the resulting carrier particle surface has sufficient tack to adhere moisture-activated coating powder to the surface of the resulting carrier particle.

A biologically active ingredient (BAT), as part of a moisture-active coating is adhered to a carrier particle via an intermediate coating of a lipophilic liquid tackifier that will not activate the moisture-active coating. The tackifier is applied to the carrier particle and then the granular biologically active ingredient (BAD), moisture-active coating or combination thereof is adhered to the tackified surface of the carrier particle. Representative tackifiers illustratively include crop oil, paraffinic oil, lamp oil, lard, tallow, linseed oil, latex, a liquid active agent, and combinations thereof, Tackifiers typically constitute 0.1 to 5 total weight percent of a tackified carrier particle. Preferably, biologically active ingredient (BAI) and/or moisture-active coating powder is sized such that the powder grain diameter has a mean particle diameter of less than 10% that of the carrier particle diameter. More preferably, the biologically active ingredient (BAI) powder has a mean diameter of less than 2% that of the carrier particle diameter. Effectively, any conventional active agent powder is operative within the present invention. It is appreciated that multiple active agents are readily formulated within a powder operative herein.

Preferably, if a liquid tackifier is used, the powdered biological active ingredient is chosen to afford a measure of synergy in effect therebetween. Synergistic effect is noted where less of an active agent is necessary to achieve a given effect when that agent is delivered in concert with a second agent. Biological synergy is obtained when two or more active agents are present within an inventive granule and operate on different plant species, different life stages of a plant, or act simultaneously on a single plant species. The selection of the inventive components can also be made to afford a chemical synergism.

A moisture-active coating illustratively includes gum arabic, guar gum, gum karaya, gum tragacanth, and locust bean gum. The moisture-active coating constitutes in an amount of 0.5% to 10% by weight of the total dry weight of an inventive granule. In one particular instance according to the present invention, water dispersible polymers are combined to a moisture-active coating and the resulting mixture is sprayed onto inventive granules.

An inventive granule is readily formed by spray coating a tackifier onto carrier particle being conveyed through a spray stream. Optionally, a carrier particle over coated with a powder active agent coating, moisture-active coating, or combination thereof is dried for a period of time prior to introduction of the powder adherent to the liquid tackifier coating. An air mixer is particularly well suited for the adherence of active agent powder while mitigating excessive damage to inventive granules so formed.

It is appreciated that the present invention affords a more efficient usage of an active agent through initial broadcast adhesion to plant foliage. Additionally, cutting of foliage so treated and allowing the clippings to remain in contact with the treatment area provides a second opportunity for adhered active agents to provide an intended action. A lesser quantity of active agent is thereby used to achieve a desired result relative to conventional active carriers and usage techniques.

### EXAMPLES

### Example 1

### Preparation of Carrier Granule with Active within Particle

Using a pan agglomeration disk, the following components are combined and mixed: 2 kilograms of +100 and 40 mesh (0.15-0.42 mm)limestone particulate, 1.8 grams of clopyralid, 1.5 grams iprodione as a pesticide, 80 grams of calcium lignosulfonate as a binder, 60 grams of glycerol as a plasticizer. The agglomeration disk is operated and adjusted to generate carrier particles in a size ranging from 800 to 2000 microns before the particles are conveyed to a fluid bed dryer where the particles are dried to contain less than 0.5% moisture by weight at a temperature of 1400 Fahrenheit. The particles are then separated into various size categories using conventional gyroscopic screeners. Carrier particles with mean a size of 11000 microns (from Example 1) are fed to a blender (Forberg fluidized zone blender). The carrier particles are sprayed with crop oil mist as lipophilic tackifiers to form a thin layer of crop oil constituting 1% total weight of the carrier particles. The resulting tackified carrier particles are sprayed with a guar gum solution. After coating with the guar gum solution, the resulting granule contains guar gum of 5% by weight of the carrier particles. It is noted that application of carrier granules of a particular size depends on the type of plant leaf or stalk. Inventive granules have a size of +¾ inch mesh and −¼ inch mesh (6.3-19 mm) are applied to pre-moistened turf at a broadcast density of clopyralid of 0.08 kg active ingredient per hectacre.

Greater than 95 number % of the granules are noted to adhere to the blade and stalk surfaces.

### Example 2

### Carrier Granules Preparation with Active Coating

The procedure of Example 1 is repeated with the exception that the clopyralid is dissolved in the crop oil and the iprodione is omitted. The resulting granules perform as detailed in Example 1.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A biologically active ingredient carrier granule comprising:
a carrier particle having a surface;
a lipophilic tackifier coated on the surface;
a moisture-activated coating adhered to said carrier particle by contact with said tackifier; and
a biological active ingredient within said carrier particle.

2. The granule of claim 1 wherein the carrier particle has a size from 500 to 3000 microns.

3. The granule of claim 1 wherein the carrier particle is a fragmented material selected from the group consisting of rock dust, clay, corncob, cereal, hulls, plant pup, and limestone.

4. The granule of claim 1 wherein said lipophilic tackifier comprises crop oil, paraffinic oil, lamp oil, lard, tallow, linseed oil, latex, and combinations thereof.

5. The granule of claim 1 wherein said biologically active ingredient is selected from the group consisting of: herbicide, insecticide, fungicide, plant growth regulator, pest reproductive control agent, pesticide, and combinations thereof.

6. The granule of claim 1 wherein said moisture-activated coating is selected from the group consisting of gum Arabic, guar gum, gum karaya, gum tragacanth, locust bean gum, and combinations thereof.

7. The granule of claim 1 wherein said carrier particle further comprising a binder component.

8. The granule of claim 1 wherein said carrier particle further comprising a plasticizer in an amount ranging from 1 to 10 total weight percent of said granule.

9. The granule of claim 8 wherein said plasticizer is selected from the group consisting of polyols, urea, sugars, sugar alcohols, oxa diacids, diglycolic acids, linear carboxylic acids with at least one ether group, C₁-C₁₂ dialkyl phthalate, ethanolacetamide, ethanolformamide, triethanolamines, thiocyanates, glycerol, triethylene glycol, propylene glycol, sorbitol, and polyethylene glycol having an average molecular weight below about 600.

10. The granule of claim 1 wherein said moisture-activated coating has a water dispersible polymer present.

11. The granule of claim 10 wherein said dispersible polymer is selected from the group consisting of polyvinyl alcohol, polyethylene glycol, polyethylene oxide, polyvinyl pyrrolidone, cellulose ether, and hydroxypropyl starch.

12. A biologically active ingredient carrier granule comprising:
a carrier particle having a surface;
a lipophilic tackifier coated on the surface;
a moisture-activated coating adhered to said carrier particle by contact with said tackifier; and
a biological active ingredient within said moisture-activated coating.

13. The granule of claim 12 wherein the carrier particle has a size from 500 to 3000 microns.

14. The granule of claim 12 wherein the carrier particle is a fragmented material selected from the group consisting of rock dust, clay, corncob, cereal, hulls, plant pup, and limestone.

15. The granule of claim 12 wherein said lipophilic tackifier comprises crop oil, paraffinic oil, lamp oil, lard, tallow, linseed oil, latex, and combinations thereof.

16. The granule of claim 12 wherein said biologically active ingredient is selected from the group consisting of: herbicide, insecticide, fungicide, plant growth regulator, pest reproductive control agent, pesticide, and combinations thereof.

17. The granule of claim 12 wherein said moisture-activated coating is selected from the group consisting of gum Arabic, guar gum, gum karaya, gum tragacanth, locust bean gum, and combinations thereof.

18. The granule of claim 12 wherein said carrier particle Her comprising a binder component.

19. The granule of claim 12 wherein said carrier particle further comprising a plasticizer.

20. The granule of claim 12 wherein said moisture-activated coating has a water dispersible polymer.

21. The granule of claim 20 wherein said dispersible polymer is selected from the group consisting of polyvinyl alcohol, polyethylene glycol, polyethylene oxide, polyvinyl pyrrolidone, cellulose ether, and hydroxypropyl starch.

22. A process for treating a foliage target area with an active agent comprising:
dispersing the granule of claim 1 onto the target area;
allowing sufficient time for the active agent to function while adhered to foliage within the target area;
cutting the foliage within the target area to yield clippings; and
leaving the clippings within the target area.

23. A process for treating a foliage target area with an active agent comprising:
dispersing the granule of claim 14 onto the target area;
allowing sufficient time for the active agent to function while adhered to foliage within the target area;
cutting the foliage within the target area to yield clippings; and
leaving the clippings within the target area.
